(19) United States
(12) Patent Application Publication
(10) Pub. No.: US 2014/0204038 A1
(43) Pub. Date: Jul. 24, 2014

(54) INFORMATION APPARATUS AND INFORMATION PROCESSING METHOD

(71) Applicant: Kabushiki Kaisha Toshiba, Tokyo (JP)

(72) Inventors: Isao Ohba, Tokyo (JP); Dai Oyama, Tachikawa-shi (JP); Hiromichi Suzuki, Hamura-shi (JP); Saori Michihata, Sagamihara-shi (JP)

(73) Assignee: Kabushiki Kaisha Toshiba, Tokyo (JP)

(21) Appl. No.: 14/014,021

(22) Filed: Aug. 29, 2013

Related U.S. Application Data
(63) Continuation of application No. PCT/JP2013/058508, filed on Mar. 25, 2013.

(30) Foreign Application Priority Data
Jan. 21, 2013 (JP) 2013-008823

(51) Int. Cl. G06F 3/0354; G06F 3/041

(52) U.S. Cl. CPC G06F 3/03545; G06F 3/041
USPC 345/173

(57) ABSTRACT

An information apparatus according to an embodiment includes a first input device for carrying out a pen input, a second input device for carrying out a touch panel input, and a correction processor for correcting a first coordinate detected by the first input device based on a second coordinate detected by the second input device.

### CROSS REFERENCE TO RELATED APPLICATIONS

This application is a Continuation Application of PCT Application No. PCT/JP2013/058508, filed Mar. 25, 2013 and based upon and claiming the benefit of priority from Japanese Patent Application No. 2013-008823, filed Jan. 21, 2013, the entire contents of all of which are incorporated herein by reference.

### FIELD

Embodiments described herein relate generally to information apparatus and an information processing method.

### BACKGROUND

In a conventional tablet apparatus and the like, it is necessary to correct an input error caused when a pen is inclined and to obtain a precise position coordinate of a pen tip. Therefore, a tablet apparatus and the like includes a pen, a tablet, a peak position detecting CPU, and a coordinate calculating CPU.

The pen inputs data by generating a magnetic field. The tablet includes a panel and sense coils of two layers. The sense coils are arranged in an XY-direction in a matrix state in the panel and disposed away from each other a predetermined distance. The peak position detecting CPU detects electromotive forces induced at the sense coils by a magnetic field generated when a pen inputs data and detects peak positions at two positions in the XY-direction, respectively. The coordinate calculating CPU calculates a position coordinate of a pen tip in the XY-direction instructed onto a tablet surface from a distance between the peak positions at the two positions and the sense coils and from a distance between a sense coil of an upper layer and a tablet surface.

However, in the conventional technology, an angle of an inclined pen is calculated from a difference of distributions of magnetic field strengths of two digitizers having a different vertical distance from the pen and a coordinate position is corrected. When vertical distances of the two digitizers are close to each other, it is difficult to detect a difference between distributions of magnetic fields. Further, when the coils are disposed close to each other, precise positions of the magnetic fields cannot be independently detected due to an interference between the coils, which is not suitable to reduce a thickness of a terminal.

There has been required a technology for obtaining a more precise position coordinate of a pen tip in a tablet apparatus and the like.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an exemplary outside appearance of electronic apparatus according to an embodiment.

FIG. 2 is a block diagram showing an exemplary system configuration of the electronic apparatus according to the embodiment.

FIG. 3 is a characteristic view to explain exemplary characteristics of magnetic fields detected by digitizers according to the embodiment.

FIG. 4 is a view showing an exemplary concept according to the embodiment.

FIG. 5 is a flowchart showing an exemplary coordinate correction in the embodiment.

FIG. 6 is a view showing an exemplary concept of a variable angle according to the embodiment.

FIG. 7 is an explanatory view showing an exemplary ratio at the time a detailed angle of a main portion in the embodiment varies.

FIG. 8 is a supplementary view of FIG. 6 and FIG. 7.

### DETAILED DESCRIPTION

Various embodiments will be described hereinafter with reference to the accompanying drawings.

An information apparatus according to an embodiment includes a first input device for carrying out a pen input, a second input device for carrying out a touch panel input, and a correction processor for correcting a first coordinate detected by the first input device based on a second coordinate detected by the second input device.

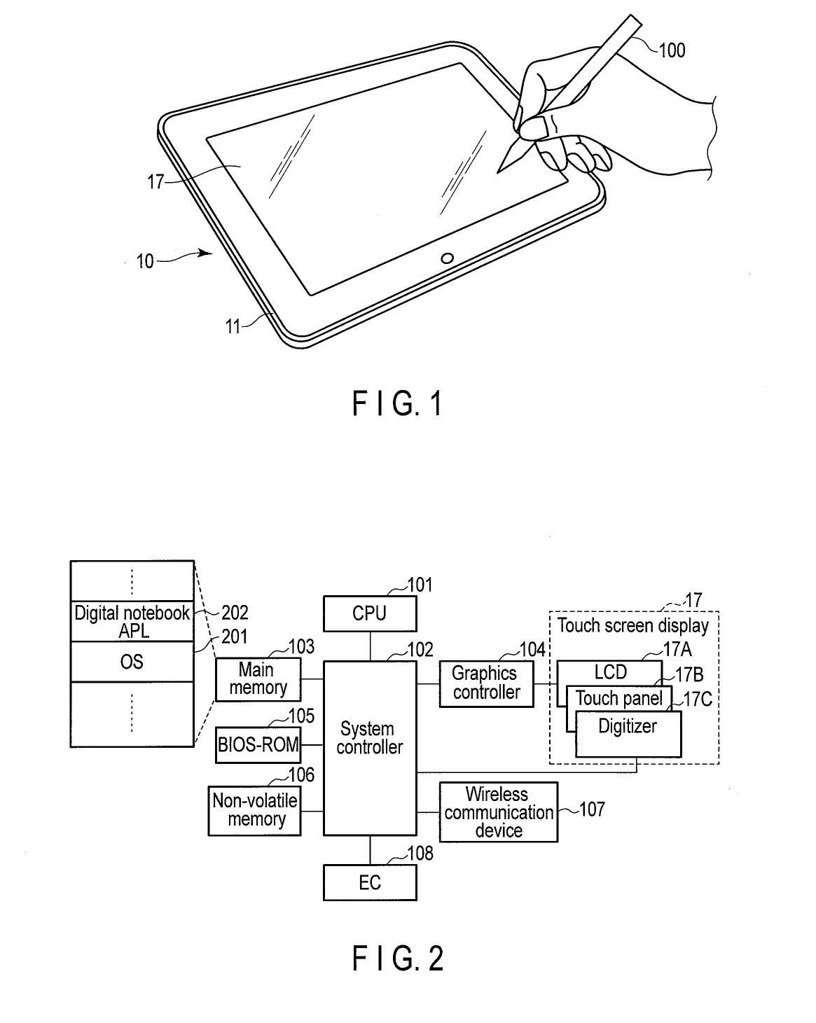

FIG. 1 is a perspective view showing an outside appearance of electronic apparatus which is an embodiment of information apparatus. The electronic apparatus is a pen-based mobile electronic apparatus capable of carrying out a handwritten input by, for example, a pen or a finger. The electronic apparatus can be realized as a tablet computer, a notebook personal computer, a smart phone, a PDA, and the like. A case that the electronic apparatus is realized as a tablet computer 10 will be assumed below. The tablet computer 10 is a mobile electronic apparatus called also a tablet or a slate computer and includes a main body 11 and a touch screen display 17 as shown in FIG. 1. The touch screen display 17 is attached such that it is overlapped on an upper surface of the main body 11.

The main body 11 has a thin box-shaped housing. In the touch screen display 17, a flat panel display and a sensor for detecting a contact position of a pen or a finger on a screen of the flat panel display is assembled. The flat panel display may be, for example, a liquid crystal display device (LCD). As the sensor, for example, a touch panel employing an electrostatic capacitance system, a digitizer employing an electromagnetic induction system, and the like may be used. A case that both two types of sensors, i.e., a digitizer and a touch panel are assembled in the touch screen display 17 will be assumed below.

Each of the digitizer and touch panel touch is disposed to cover the screen of the flat panel display. The touch screen display 17 can detect not only a touch operation carried out on a screen using a finger but also a touch operation carried out on a screen using a pen 100. The pen 100 may be, for example, an electromagnetic induction pen. A user can carry out a handwritten input operation on the touch screen display 17 using the external object (pen 100 or finger). During the handwritten input operation, a locus of a motion of an external object (pen 100 or finger) on the screen, that is, a locus (hand writing) of a stroke handwritten by the handwritten input operation is drawn at real time so that loci of respective strokes are displayed on the screen. A locus of a movement of the external object while the external object is in contact with the screen corresponds to a stroke. A set of many strokes corresponding to handwritten characters, figures, or the like, that is, a set of many loci (hand writings) configures a handwritten document.

In the embodiment, the handwritten document is not image data, and is stored in a storage medium as time series information showing a coordinate string of the loci of the respective strokes and an order of the strokes. The time series information generally means a set of time series stroke data corresponding to plural strokes, respectively. The respective stroke data corresponds to a stroke and includes a coordinate data series (time series coordinate) corresponding to each of points on a locus of the stroke. An arranging order of the stroke data sequentially corresponds to an order in which strokes are handwritten, i.e., to a stroke order.

The tablet computer 10 can read an existing optional time series information from the storage medium and display a locus corresponding to each of plural strokes shown by a handwritten document corresponding to the time series information, that is, shown by the time series information. The tablet computer 10 has an edit function. In response to an edit operation of a user using “an eraser” tool, a range designating tool, and other various tools, and the like, the edit function can delete or move an optional stroke or an optional handwritten character, and the like in a handwritten document being displayed. Further, the edit function includes a function for cancelling a history of handwriting operations.

In the embodiment, the time series information (handwritten document) can be managed as a page or plural pages. In the case, the time series information (handwritten document) may be sectioned in an area unit in which the information can be accommodated in a screen in order to record a unity of the time series information accommodated in the screen as a page. Otherwise, a size of a page may be made variable. In the case, since the size of the page can be expanded to an area larger than a size of a screen, a handwritten document having an area larger than the size of the screen can be handled as a page. When a page cannot be displayed in its entirety at the same time, the page may be reduced or a display target in the page may be moved by a longitudinal/lateral scroll.

FIG. 2 is a view showing a system configuration of the tablet computer 10.

As shown in FIG. 2, the tablet computer 10 includes a CPU 101, a system controller 102, a main memory 103, a graphics controller 104, a BIOS-ROM 105, a non-volatile memory 106, a wireless communication device 107, an embedded controller (EC) 108, and the like.

The CPU 101 is a processor for controlling operations of various modules in the tablet computer 10. The CPU 101 executes various software loaded on the main memory 103 from the non-volatile memory 106 that is a storage device. The software includes an operating system (OS) 201 and various application programs. A digital notebook application program 202 is included in the application program. The digital notebook application program 202 has a function for creating and displaying a handwritten document, a function for editing the handwritten document, a function for recognizing a character and a diagram, and the like.

Further, the CPU 101 executes also a basic input/output system (BIOS) in the BIOS-ROM 105. The BIOS is a program for controlling hardware.

The system controller 102 is a device for connecting between a local bus of the CPU 101 and various components. The system controller 102 also has a built-in memory controller for access controlling the main memory 103. Further, the system controller 102 has also a function for communicating with the graphics controller 104 via a PCI EXPRESS standard serial bus and the like.

The graphics controller 104 is a display controller for controlling an LCD 17A used as a display monitor of the tablet computer 10. A display signal created by the graphics controller 104 is sent to the LCD 17A. The LCD 17A displays a screen image based on the display signal. The LCD 17A is overlapped with a touch panel 17B and a digitizer 17C. The touch panel 17B is an electrostatic capacitance pointing device for carrying out an input on a screen of the LCD 17A. A contact position on the screen with which a finger and a hand come into contact, a movement of the contact position, and the like are detected by the touch panel 17B. The digitizer 17C is an electromagnetic induction pointing device for carrying out an input on the screen of the LCD 17A. A position (coordinate) of the pen 100 on the screen with which the pen 100 comes into contact, a movement of the position of the pen 100, and the like are detected by the digitizer 17C. The digitizer 17C outputs a coordinate showing the position of the pen 100 on the screen.

The wireless communication device 107 is a device for carrying out a wireless communication such as a wireless LAN communication, a 3G mobile communication, and the like. The EC 108 is a one-chip microcomputer comprising an embedded controller for managing power. The EC 108 has a function for turning on or off a power source of the tablet computer 10 in response to a power button operation by the user.

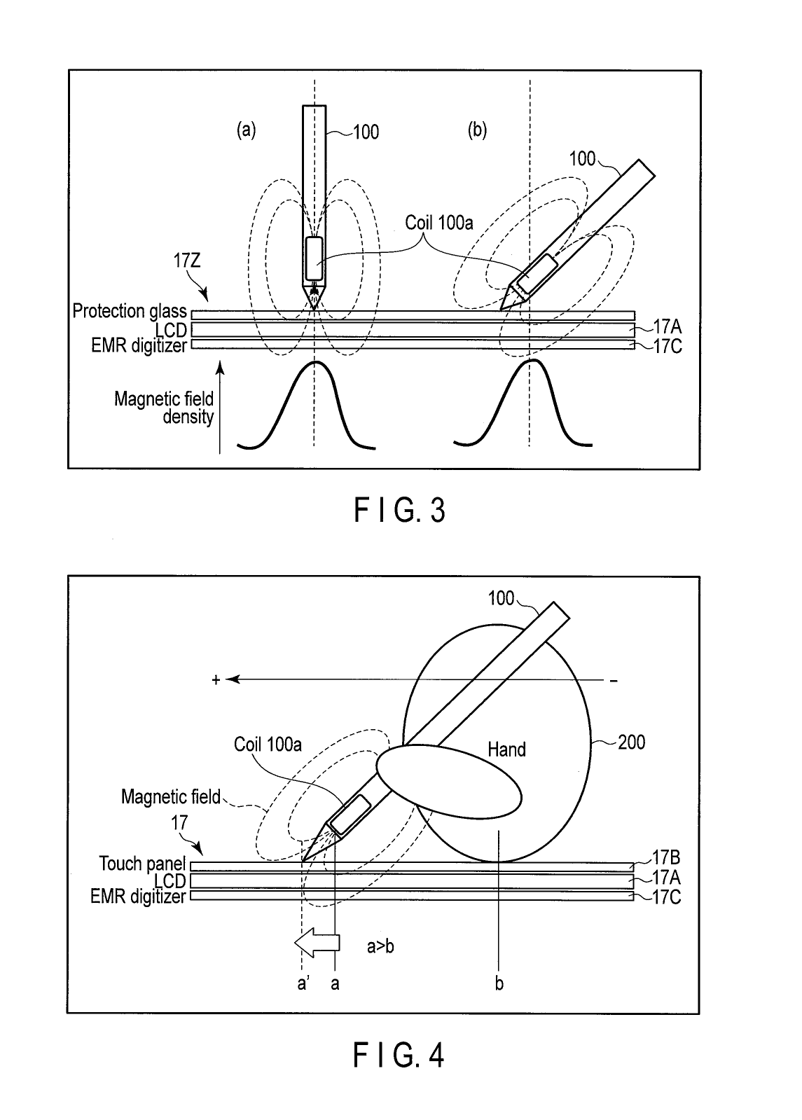

The embodiment generally relates to pen input information apparatus and a coordinate correction means of the pen input device. An operation of the embodiment will be explained using FIG. 3 to FIG. 7. The embodiment realizes an automatic correcting function of positional offset of a coordinate point caused by an inclination of a pen in an electromagnetic induction digitizer input device, for example, in the tablet computer 10.

FIG. 3 shows magnetic field characteristics of the digitizer 17C of a touch screen 17Z. The touch screen 17Z has a configuration in which the touch panel 17B is removed from the touch screen 17. In the touch screen 17Z in FIG. 3, a coordinate of a position instructed by the pen 100 is determined by an intensity when a magnetic field generated by the coil 100a in the pen 100 is received by the sensor (digitizer 17C) on a back surface of the LCD 17A. For this reason, as in (a) of FIG. 3, when the pen 100 is set vertical to a surface of the LCD 17A, a coordinate point agrees with a position of the pen tip. On the other hand, as in (b) of FIG. 3, when the pen 100 is inclined to the surface of the LCD 17A, a point where a magnetic field strength of a sensor surface is maximized is offset from a position shown by the pen tip. For this reason, a problem arises in that the user cannot draw a line at an intended position.

A conventional product employs a method of reducing the problem that a line cannot be drawn at a coordinate point by offsetting the coordinate point to left or right by previously causing a user to select whether he or she is a right-handed person or a left-handed person. The conventional method causes a problem in that the method cannot cope with that when a pen is set vertical, a coordinate point is offset and that a pen angle changes variously in mobile information apparatus such as a tablet.

A conventional technology estimates a pen angle from a difference between distributions of magnetic fields detected using two stacked digitizers and corrects coordinate points of the digitizers. Since the conventional technology makes it a premise that the two digitizers are not influenced mutually, it is necessary to provide a sufficient distance between the stacked digitizers. Accordingly, a problem arises in that when the digitizers are mounted on a mobile information terminal, a thickness of the terminal cannot be reduced.

The embodiment provides a means for reducing a thickness of a terminal and automatically correcting a positional offset of the digitizer 17C due to a pen inclination. FIG. 4 shows the embodiment. The embodiment is realized on mobile information apparatus composed of an electromagnetic induction digitizer input device, an electrostatic induction touch panel input device, and a display device for displaying a coordinate point input by the digitizer input device.

When the pen 100 is inclined as shown in FIG. 4, a difference is generated between a position of a pen tip and a detected coordinate point as shown in (b) of FIG. 3. In a large screen device such as a tablet device, since a pen input is carried out with a hand 200 put on a screen in many cases as shown in FIG. 4, a position of the hand 200 can be detected by the electrostatic capacitance touch panel 17B. Since the digitizer 17C detects only a magnetic field generated by the pen 100 and the touch panel 17B detects only a position of a dielectric of the hand 200, even if both the input devices are disposed near to each other, they keep sensing independence each other.

As shown in FIG. 4, when a position of the pen tip is shown by a′, a coordinate position detected by the digitizer 17C is shown by a, and a position of the hand 200 sensed by the touch panel 17B is shown by b. At the time, when the pen 100 is formed a linear shape, the position a′ exists on an extended line connecting the position a to the position b. When a limit of an input angle of the digitizer 17C is shown by θ_{L} and a distance from the pen tip to a coil 100a of the pen 100 is shown by d, a correction range is shown by d cos θ_{L}.

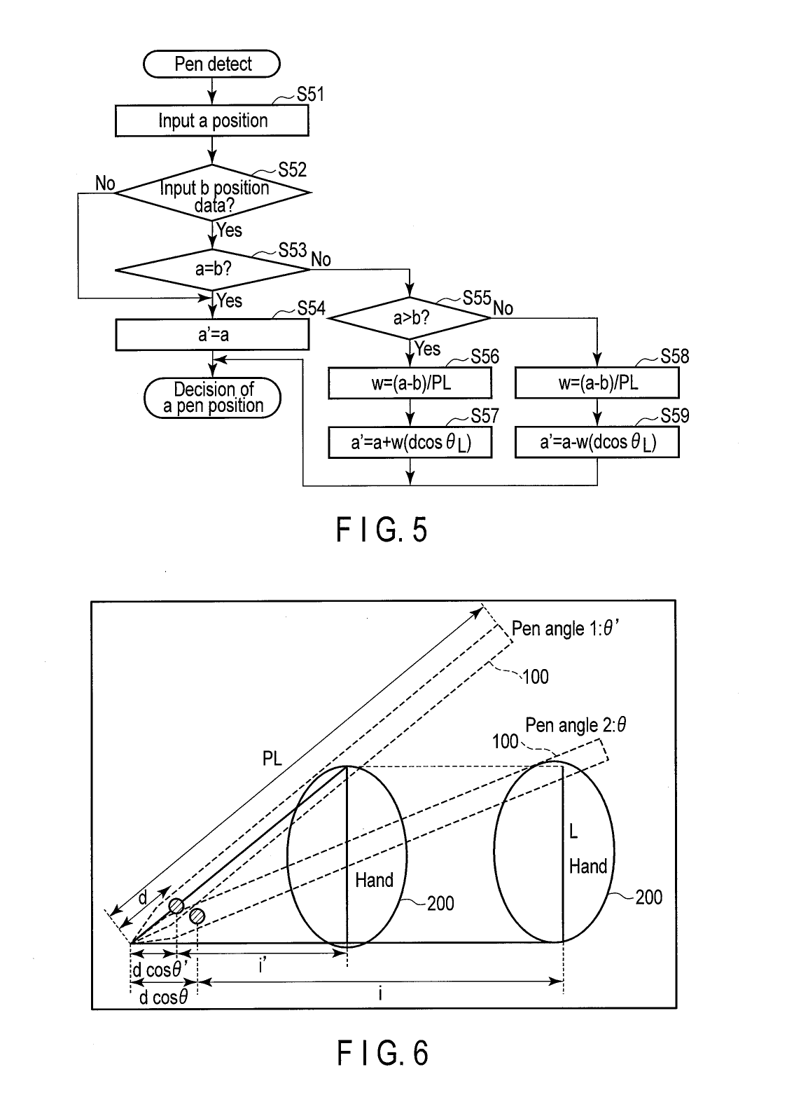

FIG. 5 shows a flowchart of a coordinate correction process. The process is carried out by a correction processor implemented by the CPU 101 using an application program developed on the main memory 103. It is sufficient to determine a direction of a corrected coordinate a′ from a positional relation between the position a and the position b shown in FIG. 4. When a=b, a coordinate is not corrected, whereas when a>b, it is sufficient to correct the coordinate to an a+wd cos θ_{L} position, and when a<b, it is sufficient to correct the coordinate to an a−wd cos θ_{L} position. At the time, w is a proportional coefficient depending on an angle of the pen 100 and can be shown by w=(a−b)/PL, (where, PL shows a length of the pen 100). A ground of w will be described later.

When coordinate information cannot be obtained by the touch panel 17B, that is, when the hand 200 does not exist on the touch panel 17B, no correction is carried out. This is because a precise pen input cannot be carried out due to fluctuation of the hand 200, it can be determined that an accuracy of a coordinate correction is not necessary.

Step S51: When the digitizer 17C detects a position on the touch screen display 17 instructed by the pen 100, the CPU 101 inputs the detected coordinate position a.

Step S52: Next, when the CPU 101 detects that the hand 200 is in touch with the touch panel 17B, the CPU 101 inputs the position b of the hand 200. When the CPU 101 inputs the position b (step S52: Yes), the process goes to next step S53, whereas when the CPU 101 does not input the position b (step S52: No), the process jumps to S54.

Step S53: The CPU 101 determine whether or not a=b, and when the determination is Yes, the process goes to next step S54, whereas when the determination is No, the process jumps to step S55.

Step S54: The CPU 101 sets a value of the corrected coordinate a′ to a and finishes the determination of position of the pen tip.

Step S55: The CPU 101 determines whether or not a>b, and when the determination is Yes, the process goes to next step S56, whereas when the determination is No, the process jumps to step S58.

Step S56: The CPU 101 calculates w=(a−b)/PL.

Step S57: The CPU 101 sets a value of the corrected coordinate a′ to a+wd cos θ_{L} and finishes the determination of position of the pen tip.

Step S58: The CPU 101 calculates w=(a−b)/PL.

Step S59: The CPU 101 sets the value of the corrected coordinate a′ to a−wd cos θ_{L} and finishes the determination of position of the pen tip.

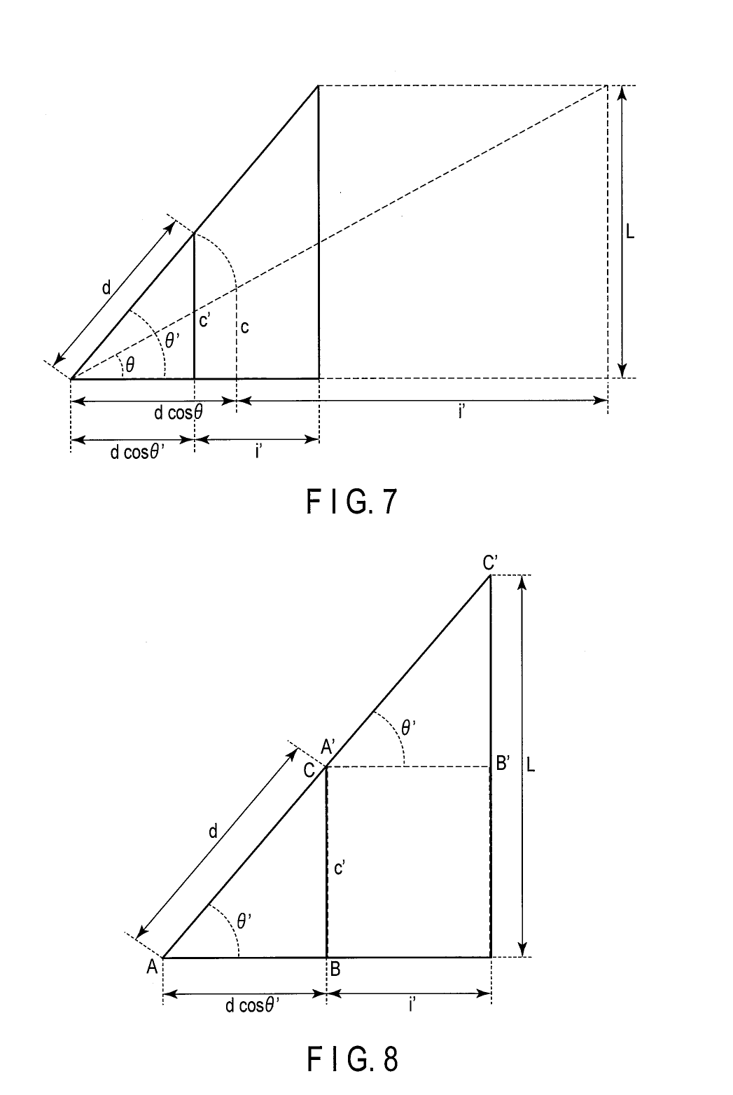

Next, FIG. 6 and FIG. 7 show the ground of calculation of the weight w at the time of inclination. When the same person carries out the pen input, as shown in FIG. 6, a correlation exists between an inclination angle θ(θ′) of the pen 100 and a position of the hand 200.

FIG. 7 geometrically shows FIG. 6. In FIG. 7, d cos θ′=c′i′/(L−c′) is established from similarity of triangles. Likewise, d cos θ′: d cos θ=c′i′/(L−c′): ci/(L−c) is established from d cos θ=ci/(L−c), wherein L shows a height of the hand 200 (height up to the pen 100 supported by the hand 200) and c (c′) shows a height of the pen 100 up to the coil 100a.

In the embodiment, since it can be assumed that the height L of the hand and the height c of the pen 100 up to the coil 100a is L>>c, a term of c of a denominator can be ignored. Accordingly, the formula can be rewritten as d cos θ′: d cos θ=c′i′: ci.

When the pen 100 is inclined largely and an influence of positional offset becomes outstanding, since an influence of c can be almost ignored, it is considered that d cos θ′: d cos θ=i is established. That is, it can be said that the weight w is proportional to a distance between the coil 100a and the hand 200 (aθb in FIG. 4). Accordingly, the weight w can be shown as a function: w=ABS (a−b)/PL that is proportional to a−b.

FIG. 8 is a supplementary view of FIG. 6 and FIG. 7 and shows a result calculated from similarity of triangles. That is, ΔABC∞ΔA′B′C′ results in d cos θ′: c′=: (L−c′), d cos θ=c′i′/(L−c′).

The term w of the embodiment is exemplarily expressed by the function and this does not restrict the embodiment. That is, since w is a weight, other method may be employed. For example, w may be simply proportional to the length i of FIG. 6 and FIG. 7.

Further, although the embodiment has been explained using the mobile information terminal (tablet computer 10) as the example, the embodiment is not restricted thereto as long as components are satisfied.

The embodiment corrects an offset between a detected coordinate point and the pen tip at the time the pen is inclined in the electromagnetic induction pen input device using a position of the hand 200 detected by the touch panel 17B.

The two different sensors, i.e., the touch panel 17B for detecting a dielectric and the digitizer 17C for detecting an electromagnetic pen used in the embodiment make it possible to dispose them near each other, and this can reduce a thickness of a terminal. With the configuration, a thin terminal capable of detecting a pen angle can be simply realized.

(1) A positional offset caused by the digitizer 17C due to an inclination of a pen can be corrected while realizing a reduction of thickness of a terminal.
(2) A positional offset can be automatically corrected at any pen angle.
(3) In a tablet device with a pen input function, a coordinate correction can be realized without any special device.

The (mobile) information apparatus described below has been explained.

(1) In mobile information apparatus including an electronic pen for generating a magnetic field, an electromagnetic induction digitizer input device composed of a sensor for detecting the magnetic field generated from the electronic pen, an electrostatic capacitance touch panel input device for detecting a dielectric, a controller IC capable of calculating a coordinate, and a display for displaying the coordinate, the electronic pen has a coil for generating a magnetic field at position away from a pen tip a distance d, the digitizer input device and the touch panel input device are configured to be able to detect coordinates independent each other, and a displayed coordinate point is corrected within a range of d cos θ_{L} centering around a coordinate detected by the digitizer input device on an extended line connecting the coordinate point detected by the digitizer input device to a coordinate point detected by the touch panel input device, wherein θ_{L} shows a limit of a movement inclination angle of the electronic pen.
(2) In the mobile information apparatus of (1), the display coordinate point of (1) is corrected to a position of (i/PL)d cos θ_{L}, wherein a distance between the coordinate point detected by the digitizer input device and the coordinate detected by the touch panel is shown by I and a pen length is shown by PL.
(3) In the mobile information apparatus of (1) and (2), when the touch panel input device detects no coordinate information, the displayed point coordinate correction of (1) is not carried out.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information apparatus comprising:
a first input device configured to carry out a pen input;
a second input device configured to carry out a touch panel input; and
a correction processor configured to correct a first coordinate detected by the first input device based on a second coordinate detected by the second input device.

2. The information apparatus of claim 1, wherein the correction processor is configured to carry out a correction based on a calculation proportional to a difference between the first coordinate and the second coordinate.

3. The information apparatus of claim 1, wherein when the second coordinate is not detected, the correction processor is configured to suppress the correction of the first coordinate.

4. The information apparatus of claim 1, wherein the first input device comprises an electromagnetic induction digitizer input device.

5. The information apparatus of claim 1, wherein the second input device comprises an electrostatic capacitance touch panel input device.

6. An information processing method comprising:
a first input step which carries out an pen input;
a second input step which carries out a touch panel input; and
a correction step which corrects a first coordinate detected at the first input step based on a second coordinate detected at the second input step.

7. The information processing method of claim 6, wherein the correction step carries out a correction based on a calculation proportional to a difference between the first coordinate and the second coordinate.

8. The information processing method of claim 6, wherein when the second coordinate is not detected, the correction step suppresses the correction of the first coordinate.

9. The information apparatus of claim 2, wherein when the second coordinate is not detected, the correction processor is configured to suppress the correction of the first coordinate.

10. The information processing method of claim 7, wherein when the second coordinate is not detected, the correction step suppresses the correction of the first coordinate.
